(19) United States
(12) Patent Application Publication
(10) Pub. No.: US 2010/0243147 A1
(43) Pub. Date: Sep. 30, 2010

(54) LAMINATING APPARATUS AND METHOD OF MANUFACTURING SEALED STRUCTURE BODY

(75) Inventors: Tomohiro Matsui, Kanagawa-ken (JP); Masaaki Furuya, Kanagawa-ken (JP); Hiroaki Kobayashi, Kanagawa-ken (JP); Toshihiko Shinoda, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/721,098

(22) Filed: Mar. 10, 2010

(30) Foreign Application Priority Data
Mar. 25, 2009 (JP) P2009-073189

(51) Int. Cl. B32B 38/10; B29C 65/02

(52) U.S. Cl. 156/250; 156/382; 156/60

(57) ABSTRACT

A laminating apparatus including a decompression chamber, a heater table provided in the decompression chamber, and a pressing member provided above the heater table in the decompression chamber. The pressing member includes an elastic sheet facing the heater table, and a supporting frame to support the elastic sheet by partitioning and to form expansion chambers for partitions, each of which makes the elastic sheet expand to the heater table side by a pressure of a fed gas.

### CROSS-REFERENCE TO RELATED APPLICATIONS

This application is based upon and claims the benefit of priority from the prior Japanese Patent Application No. 2009-73189, filed on Mar. 25, 2009; the entire contents of which are incorporated herein by reference.

### BACKGROUND OF THE INVENTION

1. Field of the Invention

The present invention relates to a laminating apparatus and a method of manufacturing a sealed structure body.

2. Description of the Background

A flat display device which is one of sealed structure bodies is used in various apparatuses such as a computer display and a portable terminal and so on. Regarding the flat display device, an organic EL (Electro Luminescence) display device is developed, for example. The organic EL display device can be made thinner than a liquid display device and a plasma display device and so on, and is also a display device which can emit self-luminescence in the same manner as the plasma display device.

In the manufacturing process of manufacturing a flat display device, a laminating apparatus is used. This laminating apparatus is composed of an upper chamber with a diaphragm capable of expanding in the lower direction and a lower chamber provided with a heater table. This laminating apparatus closes the upper chamber and the lower chamber in air tight manner and decompress, at the state that a body to be laminated is loaded on the heater table. Then, the body to be laminated is heated, and the body to be laminated is sandwiched and pressed between the upper surface of the heater table and the diaphragm so as to laminate by inducing atmosphere in the upper chamber. (Refer to Patent Document 1 described below, for example).

In case of imposing and manufacturing a plurality of display areas on a glass substrate by such a laminating apparatus, a plurality of resin sheets are arranged on the glass substrate which will become a body to be laminated. Then, each of the resin sheets on the glass substrate is pressed to remove air bubbles, and each of the resin sheets is contacted tightly to the glass substrate by a diaphragm of the laminating apparatus. In this time, the diaphragm of the laminating apparatus covers completely each of the resin sheets so as to contact tightly with whole the surface of the glass substrate.

In addition, frit materials as sealing materials are coated on the glass substrate in a frame shape so as to form a plurality of frit frames, and resin sheets are arranged on the glass substrate inside these frit frames. The resin sheet is formed by laminating a protective film on a filling material. As the resin sheet is loaded on the glass substrate inside the frit frame, the filling material is fed inside the frit frame.

Patent Document 1: Japanese Patent No. 3,655,076

But, in case that each of the resin sheets is contacted tightly with the glass substrate while removing air bubbles by the diaphragm as described above, as the diaphragm contacts the surface of the glass substrate except the resin sheet and the frit frame, they may be contaminated.

In addition, the filling material which has run off from the resin sheet attaches to the diaphragm, and this may become a cause of dusts or may become a cause of contaminating the surface of the glass or the frit frame. In addition, by a manner in which the diaphragm contacts with the glass substrate and the resin sheet, an exhaust route may not be ensured, so that the removed states of the air bubbles may vary.

### SUMMARY OF THE INVENTION

Accordingly, an object of the present invention is to provide a lamination apparatus and a method of manufacturing a sealed structure body which can prevent the contamination of the product, and in addition can laminate without leaving air bubbles.

According to an aspect of the present invention, there is provided a laminating apparatus, including a decompression chamber, a heater table provided in the decompression chamber, and a pressing member provided above the heater table in the decompression chamber. The pressing member includes an elastic sheet facing the heater table, and a supporting frame to support the elastic sheet by partitioning and to form expansion chambers for partitions, each of which makes the elastic sheet expand to the heater table side by a pressure of a fed gas.

According to another aspect of the present invention, there is provided a method of manufacturing a sealed structure body using a laminating apparatus, comprising a decompression chamber, a heater table provided in the decompression chamber, and a pressing member provided above the heater table in the decompression chamber, the pressing member including, an elastic sheet facing the heater table, and a supporting frame to support the elastic sheet by partitioning and to form expansion chambers for partitions, each of which makes the elastic sheet expand to the heater table side by a pressure of a fed gas. The method includes, loading a body to be laminated on which a plurality of laminating materials are loaded on the heater table, and laminating the laminating materials on the body to be laminated while pressing the laminating materials by the pressing member.

According to the present invention, a lamination apparatus and a method of manufacturing a sealed structure body can prevent the contamination of the product, and in addition, can laminate without leaving air bubbles.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram showing a construction of a laminating apparatus according to an embodiment of the present invention;

FIG. 2 is a perspective view showing a pressing member provided in the laminating apparatus shown in FIG. 1; and

FIG. 3 is an explanation diagram for explaining a lamination operation performed by the laminating apparatus shown in FIG. 1.

### DETAILED DESCRIPTION OF THE INVENTION

Referring now to the drawings, wherein like reference numerals designate identical or corresponding parts throughout the several views, the embodiments of this invention will be described below.

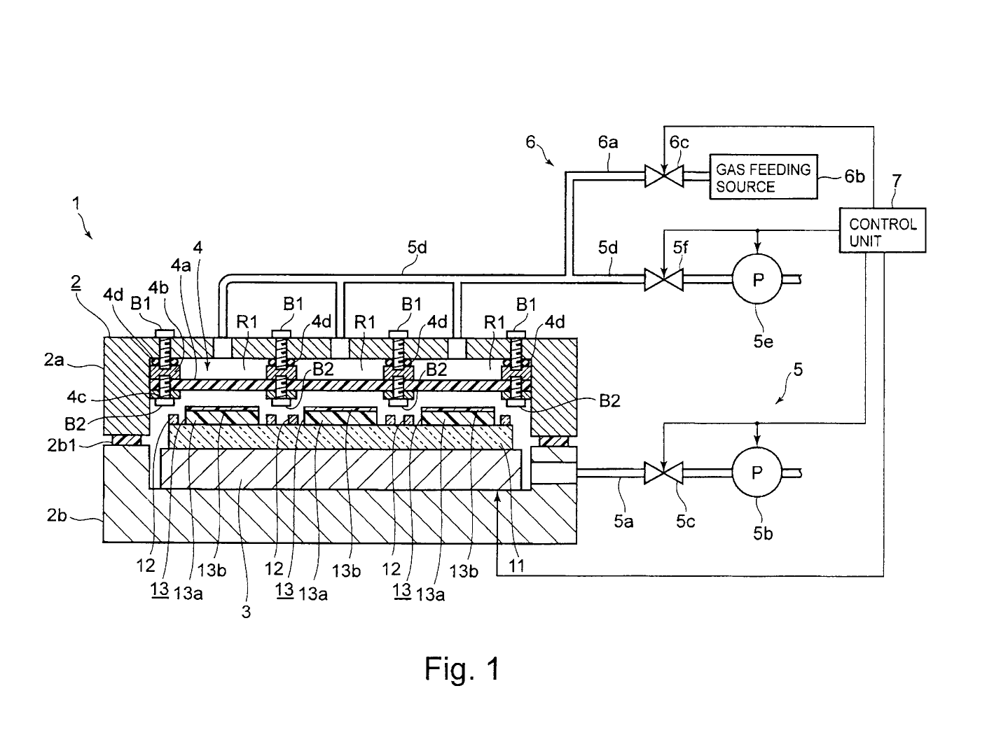

As shown in FIG. 1, a laminating apparatus 1 according to an embodiment of the present invention is provided with a decompression chamber 2, a heater table 3 provided in the decompression chamber 2, a pressing member 4 provided above the heater table 3 and in the decompression chamber 2, a decompressing unit 5 to decompress inside the decompression chamber 2, a gas feeding unit 6 to feed gas as a pressing source for the pressing member 4, and a control unit to control each of the units.

The decompression chamber 2 is formed so as to be divided into an upper chamber 2a that is a first chamber and a lower chamber 2b that is a second chamber. The upper chamber 2a is an upper chamber to cover the heater table 3 from the above, and the lower chamber 2b is a lower chamber to store the heater table 3 from the below. The decompression chamber 2 has two states composed of a closed state where the upper chamber 2a and the lower chamber 2b are united and an open state where the upper chamber 2a and the lower chamber 2b are separated. On the surface of the lower chamber 2a at the upper chamber 2a side, an airtightness holding member 2b1 such as an O-ring is provided to hold airtightness.

The heater table 3 is provided so as to be fixed to the lower chamber 2b of the decompression chamber 2. The heater table 3 functions as a stage on which a substrate 11 such as a glass substrate and so on that will become a body to be laminated, and is a table to heat the substrate 11. As the heater table, a hot plate is used, for example. The heater table 3 is connected electrically to the control unit 7, and is controlled so that a temperature of the heater becomes constant at a prescribed temperature.

Here, a plurality of frame shaped frit materials 12 which have been baked are provided on the substrate 11 in a matrix state. The frit material 12 functions as a sealing material in case of bonding the substrate 11 with another substrate. In a frame of each of the frit materials 12, a resin sheet 13 is loaded which will become a laminating material. The resin sheet 13 is composed by laminating a protective film 13b on a filling material 13a. The resin sheet 13 is originally formed by sandwiching the filling material 13a with the two protective films 13b, and after one of the protective films 13b is peeled off, the resin sheet 13 is arranged on the substrate 11.

The filling material 13a is a thermosetting resin film which is not almost provided with adherence property at normal temperature, melts at a prescribed temperature to increase adherence property, and cures at a further high prescribed temperature. In addition, the protective film 13b is a film to protect the filling material 13a from ambient air (attachment of dirt and dust and so on) and an eternal force.

The pressing member 4 is provided with an elastic sheet 4a such as a diaphragm, and a first supporting frame 4b and a second supporting frame 4c which nip and support the elastic sheet 4a. The pressing member 4 is provided in the upper chamber 2a of the decompression chamber 2 above the heater table 3.

The elastic sheet 4a is separated from the heater table 3 by a prescribed distance and is located above the heater table 3, and is a deformable sheet so as to expand in the direction of the heater table 3 side. An elastic body such as Silicone and Viton and so on is used for the elastic sheet 4.

The first supporting frame 4b is fixed to the upper chamber 2a of the decompression chamber 2 by a plurality of fixing members 81 such as bolts and so on, and the second supporting frame 4c is fixed to the first supporting frame 4b via the elastic sheet 4 by a plurality of fixing members 82 such as bolts and so on. Thus, the second supporting frame 4c, the elastic sheet 4a and the first supporting frame 4b are laminated in this order and are integrated into one body by fixing members B2 to compose the pressing member 4. The pressing member 4 is detachable to and from the upper chamber 2a by each of the fixing members B1.

In addition, the first supporting frame 4b is a frame body which partitions and supports the elastic sheet 4 adapted to a size of the resin sheet 13 and forms expansion chambers R1 per partition, each of which makes the elastic sheet 4a expand to the heater table 3 side by the pressure of the fed gas. That is, the first supporting frame 4b forms side walls for each of the expansion chambers R1, and the elastic sheet 4a forms the bottom surfaces of the expansion chambers R1, respectively.

Here, a partition size of the elastic sheet 4a is set as described below. A part of the elastic sheet 4a which is the bottom surface of one expansion chamber R1 can press whole the surface of the resin sheet 13 (the surface at the elastic sheet 4a side) on the substrate 11 on the heater table 3 and does not contact except the surface of the resin sheet 13.

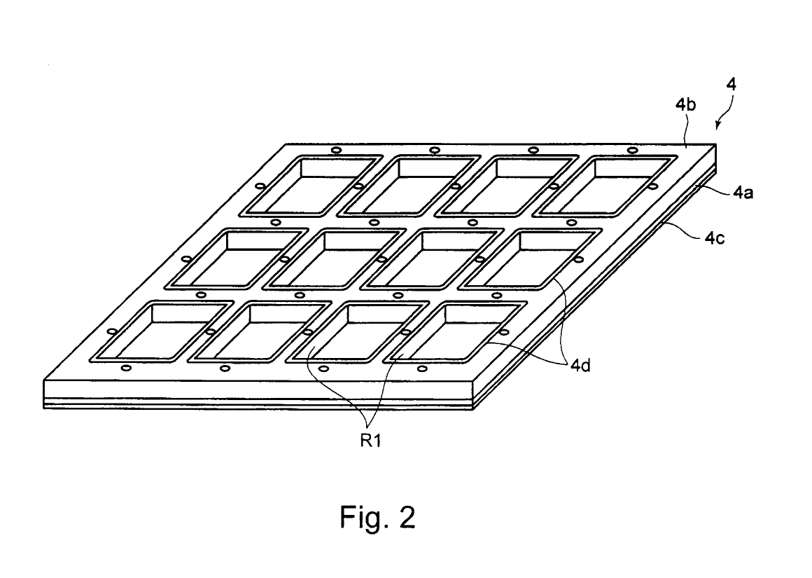

In addition, a plurality of airtightness holding members 4d such as O-rings and so on are provided at the surface of the first supporting frame 4b at the upper chamber 2a side. Each of the airtightness holding members 4d is provided along the opening portion of each of the expansion chambers R1 as shown in FIG. 2, and keeps the airtightness of the each of the expansion chambers R1 at the state that the pressing member 4 is attached to the upper chamber 2a.

The decompressing unit 5 is an exhaust unit to exhaust inside the decompression chamber 2. The decompressing unit 5 is provided with an exhaust pipe 5a to communicate with the inside of the lower chamber 2b of the decompression chamber 2, a pump 5b to exhaust inside the decompression chamber 2 via the exhaust pipe 5a, and a valve 5c provided midway in a route of the exhaust pipe 5a. An on-off valve such as an electromagnetic valve and a butterfly valve and so on is used for the valve 5c. The pump 5b and the valve 5c are electrically connected to the control unit 7, the valve 5c is opened in accordance with the control of the control unit 7, and the pump 5b sucks in and exhausts the gas in the decompression chamber 2 in accordance with the control of the control unit 7

In addition, the decompressing unit 5 is provided with an exhaust pipe 5d to communicate with the inside of the upper chamber 2a of the decompression chamber 2, that is each of the expansion chambers R1 of the pressing member 4, a pump 5e to exhaust inside each of the expansion chambers R1 via the exhaust pipe 5d, and a valve 5f provided midway in a route of the exhaust pipe 5d. An on-off valve such as an electromagnetic valve and a butterfly valve and so on is used for the valve 5f. The pump 5e and the valve 5f are electrically connected to the control unit 7 too, the valve 5f is opened in accordance with the control of the control unit 7, and the pump 5e sucks in and exhausts the gas in each of the expansion chambers R1 in accordance with the control of the control unit 7.

The gas feeding unit 6 is a feeding unit to feed gas such as compressed air to each of the expansion chambers R1 of the pressing member 4. The gas feeding unit 6 is provided with a feed pipe 6a to communicate with the exhaust pipe 5d which is connected to each of the expansion chambers R1 of the pressing member 4, a gas feeding source to feed the gas to each of the expansion chambers R1 via the feed pipe 6a, and a valve 6c provided midway in a route of the feed pipe 6a. An on-off valve such as an electromagnetic valve and a butterfly valve and so on is used for the valve 6c. The valve 6c is electrically connected to the control unit 7, and opens or closes the feed pipe 6a in accordance with the control of the control unit 7.

The control unit 7 is provided with a controller to control each of the units in a concentrated manner and a memory unit to store various programs and various data and so on. A RAM (Random Access Memory) which functions as a work area of the controller, a nonvolatile memory and a hard disk drive and so on are used for the memory unit, for example. The control unit 7 executes controlling each of the units and a series of data processing to perform calculation or processing and so on of the data, based on the various programs and various data stored in the memory unit.

In particular, the control unit 7 performs lamination treatment so as to laminate the resin sheet 13 to the substrate 11 on the heater table 3. The lamination treatment includes decompression treatment to perform decompression and pressing treatment to perform pressing. In addition, the memory unit stores condition informations such as the decompression condition and pressing condition and so on.

Next, a lamination operation (a manufacturing method) performed by the above-described laminating apparatus 1 will be described. In addition, the control unit 7 of the laminating apparatus 1 performs the lamination treatment to control each of the units.

First, the upper chamber 2a of the decompression chamber 2 is opened and the decompression chamber 2 becomes in the opened state, and the substrate 11 is supplied on the heater table 3 by a carrying mechanism such as a robot hand and so on. The heater table 3 is heated to about 80° C. Then, the upper chamber 2a of the decompression chamber 2 is closed, the decompression chamber 2 becomes in the closed state, and the inside of the decompression chamber 2 is kept airtight.

In addition, a plurality of resin sheets 13 are arranged on the substrate 11 in a matrix state. For the filling material 13a composing the resin sheet 13, a thermosetting resin film is used which is not almost provided with adherence property at normal temperature, melts when heated to about 80° C. and is provided with adherence property, and cures when heated not less than 100° C.

Next, the pump 5b and the pump 5e both for exhaust are driven, the valve 5c and valve 5f are opened, both the insides of the lower chamber 2b and the upper chamber 2a (inside each of the expansion chambers R1 of the pressing member 4) of the decompression chamber 2 are exhausted and decompressed. In this time, as the lower chamber 2b is decompressed, the air (air bubbles) between the substrate 11 and each of the resin sheets 13 is exhausted.

Then, when the insides of the upper chamber 2a and the lower chamber 2b become in the state decompressed to about 100 Pa, the valve 5f for exhaust is closed, and the pump 5e is stopped. Next, the valve 63 for feeding is opened, and air with a positive pressure (compressed air) is fed from the gas feeding source 6b via the feed pipe 6a to the inside of the upper chamber 2a of the decompression chamber 2, that is, each of the expansion chambers R1 of the pressing member 4. The compressed air is pressure controlled in a stepwise manner by a regulator provided in the gas feeding source 6b.

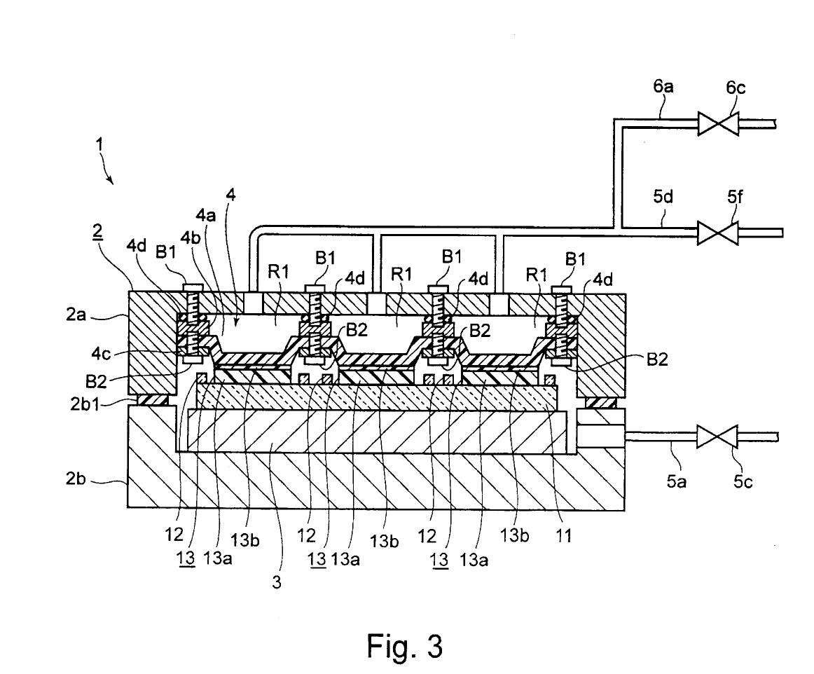

As shown in FIG. 3, when the compressed air is fed in each of the expansion chambers R1 of the pressing member 4, the elastic sheet 4a expands to the heater table 3 side for each of the expansion chambers R1 (per partition) and presses down each of the resin sheets 13 on the substrate 11. By this, the air remaining between each of the resin sheets 13 and the substrate 11 which are heated to about 80° C. are pushed out, and each of the resin sheets 13 contacts tightly with the substrate 11 completely.

As the elastic sheet 4a is provided with a construction which is divided into almost the same size as each of the resin sheets 13 arranged on the substrate 11, it is possible to press without contacting with the surface except each of the resin sheets 13 of the substrate 11. Thus, the elastic sheets 4a do not contact with the portions except each of the resin sheets 13 on the substrate 11, so that to avoid the contamination of the product can be made possible.

In addition, as the elastic sheets 4a are partitioned for each of the resin sheets 13, an exhaust route is kept to exhaust air from spaces between the substrate 11 and the resin sheets 13. By this, an exhaust trouble caused by a manner in which the elastic sheets 4a contact is eliminated, so that to exhaust surely air bubbles can made be possible. In addition, by controlling the pressure of the fed gas the pressing force can be adjusted arbitrarily in a multistage.

Then, the valve 6c for feeding is closed, the valve 5c for exhaust is opened, and in addition, the valve 5b for exhaust is closed so as to open to the atmosphere. Next, the upper chamber 2a of the decompression chamber 2 is opened and the decompression chamber 2 becomes in the opened state, and then the substrate 11 is taken out from on the heater table 3 by the carrying mechanism such as the robot hand and so on and is carried to the next process.

The protective film 13b is pasted on the filling material 13a composing the resin sheet 13. In a next process, firstly a sheet peeling off apparatus is used, and each of the protective film 13b is peeled off from each of the resin sheets 13 on the substrate 11. To peel off the sheet is performed under the atmosphere of an inert gas such as nitrogen and so on.

Next, a pasting apparatus is used, and the substrate 11 for sealing is reversed and is pasted on an array substrate. In addition, luminescent layers such as organic luminescent device films are provided on the array substrate for each of the display areas. The pasting is performed under the reduced pressure atmosphere. The substrate 11 for sealing is supported by a supporting frame of the pasting apparatus, and the array substrate is loaded on a stage of the pasting apparatus. Then, an alignment of the substrate 11 for sealing with the array substrate is performed, and the stage and the supporting frame relatively move in the approaching direction so as to contact the substrate 11 with the array substrate in a tight manner, and then the substrate 11 and the array substrate are pasted together in the pressurized state and under the reduced pressure atmosphere.

Then a laser sealing apparatus is used, and each of the frame shaped frit materials 12 locating between the substrate 11 and the array substrate in the pasted state are melted by irradiating the laser light, and is bonded to the array substrate. The irradiation of the laser light is performed under the reduced pressure atmosphere. For example, by a laser irradiating unit of the laser sealing apparatus, the laser light is irradiated to each of the frame shaped frit materials locating between the substrate 11 and the array substrate in the pasted state, and each of the frit materials 11 is melted and is bonded to the array substrate. By this, the substrate 11 for sealing and the array substrate are bonded by each of the frit materials 12.

Lastly, a baking furnace is used, and the substrate 11 and the array substrate in the bonded state are put in the baking furnace, and each of the filling materials 13a locating between them is heated and is cured. By heating, each of the filling materials 13a is softened temporarily and is melted, and expands into an internal space formed by each of the frame shaped frit materials 12, the substrate 11 and the array substrate, fills the internal space and then is cured. Then, they are cut per display area and a plurality of flat display devices (sealed structure bodies) are completed at one time.

As described above, according to the present embodiment the elastic sheet 4a is divided and supported, and the expansion chambers R1 are formed for each partition, each of which makes the elastic sheet 4a expand to the heater table 3 by the pressure of the fed gas. By this, the elastic sheet 4a expands to the heater table 3 for each partition, and does not happen to contact with the portions except the resin sheet 13 of the substrate 11. For the reason, as the surface of the substrate 11 and the frit frame are not contaminated so that the contamination of the product can be prevented. In addition, as the elastic sheet 4a does not happen to contact with the portions except the resin sheet 13 of the substrate 11, gaps can be ensured between each of a plurality of the resin sheets 13 on the substrate 11. For the reason, an exhaust route can be ensured when laminating, the remaining air between the resin sheets 13 and the substrate 11 can be surely exhausted, and it can be made possible to laminate without leaving the air bubbles. Thus, factors to invite the quality degradation of the product can be excluded, and it can be made possible to improve the quality of the sealed structure body.

In addition, by forming the pressing member 4 so as to be detachable, a plurality of pressing members 4 with different partition sizes are prepared, and as the pressing member 4 can be replaced in conformity with the size of the resin sheets 13 which are laminating materials, the convenience of the apparatus can be improved.

In the above-described embodiment, the pressing member 4 is constructed by sandwiching and supporting the elastic sheet 4a by the first supporting frame 4b and the second supporting frame 4c. But, the present invention is not limited to this, the pressing member 4 may be constructed by jointing the elastic sheet 4a to the first supporting frame 4b by an adhesive agent or welding.

In addition, in the above-described embodiment, the elastic sheet 4a composed of one sheet is used. And, the elastic sheet 4a is divided into a plurality of partitions so as to form the expansion chambers R1 in the pressing member 4. But a plurality of elastic sheets may be used instead of the elastic sheet 4a in preparing the pressing member 4, each of which is used for a partition to form the expansion chamber R1.

Obviously, numerous modifications and variations of the present invention are possible in light of the above teachings. It is therefore to be understood that within the scope of the appended claims, the invention may be practiced otherwise than as specifically described herein. In addition, in the above-described embodiment, various numerical values are listed, but these values are explained as examples, and the present invention is not limited to these values.

What is claimed is:

1. A laminating apparatus, comprising:
a decompression chamber;
a heater table provided in the decompression chamber; and
a pressing member provided above the heater table in the decompression chamber;
the pressing member including,
an elastic sheet facing the heater table, and
a supporting frame to support the elastic sheet by partitioning and to form expansion chambers for partitions, each of which makes the elastic sheet expand to the heater table side by a pressure of a fed gas.

2. The laminating apparatus as recited in claim 1, wherein:
the pressing member is formed so as to be detachable.

3. The laminating apparatus as recited in claim 1, wherein:
the decompression chamber is provided with a first chamber and a second chamber, and is formed so as to be opened and closed by the first chamber and the second chamber.

4. The laminating apparatus as recited in claim 1, further comprising:
a decompressing unit to decompress inside the decompression chamber; and
a gas feeding unit to feed the gas to the pressing member as a pressing source.

5. The laminating apparatus as recited in claim 4, wherein:
the decompression unit is composed of a first exhaust unit to exhaust air in a space between the first chamber and the pressing member, and a second exhaust unit to exhaust air in a space between the second chamber and the pressing member; and
the first exhaust unit is provided with a plurality of means, each of which exhausts each of the expansion chambers.

6. The laminating apparatus as recited in claim 4, wherein:
the gas feeding unit is provided with a plurality of means, each of which feeds the gas to each of the expansion chambers.

7. The laminating apparatus as recited in claim 1, wherein:
in the pressing member, the supporting frame is composed of a first supporting frame and a second supporting frame to sandwich and support the elastic sheet; and
the expansion chambers are provided at the first supporting frame side of the elastic sheet, and each of the expansion chambers makes the elastic sheet expand to the heater table side by the pressure of the fed gas.

8. The laminating apparatus as recited in claim 1, wherein:
a body to be laminated on which a plurality of laminating materials are loaded is adapted to be loaded on the heater table; and
by making the elastic sheet expand to the heater table side by the pressure of the fed gas, the laminating materials are laminated on the body to be laminated while being pressed.

9. A method of manufacturing a sealed structure body using a laminating apparatus, comprising a decompression chamber, a heater table provided in the decompression chamber, and a pressing member provided above the heater table in the decompression chamber, the pressing member including, an elastic sheet facing the heater table, and a supporting frame to support the elastic sheet by partitioning and to form expansion chambers for partitions, each of which makes the elastic sheet expand to the heater table side by a pressure of a fed gas;
the method comprising:
loading a body to be laminated on which a plurality of laminating materials are loaded on the heater table; and
laminating the laminating materials on the body to be laminated while pressing the laminating materials by the pressing member.

10. The method of manufacturing a sealed structure body as recited in claim 9, wherein:
by making the elastic sheet expand to the heater table side by the pressure of the fed gas, the laminating materials are laminated on the body to be laminated while being pressed.

11. The method of manufacturing a sealed structure body as recited in claim 9, wherein:
the laminating material is composed of a resin sheet.

12. The method of manufacturing a sealed structure body as recited in claim 11, wherein:
the resin sheet is composed of a thermosetting resin film.

13. The method of manufacturing a sealed structure body as recited in claim 9, wherein:
the body to be laminated is composed of a glass substrate.

14. The method of manufacturing a sealed structure body as recited in claim 9, wherein:
the body to be laminated on which laminating materials are laminated is bonded to an array substrate by a frit member; and
a plurality of the sealed structure bodies are manufactured by cutting off the body to be laminated and the array substrate which are bonded per display area.

15. The method of manufacturing a sealed structure body as recited in claim 14, wherein:
the sealed structure body is a flat display device.
